(19) United States
(12) Patent Application Publication
(10) Pub. No.: US 2012/0238675 A1
(43) Pub. Date: Sep. 20, 2012

(54) METHOD OF PRODUCING AN INK COMPOSITION FOR OFFSET PRINTING

(75) Inventors: Yuichi KATAURA, West Chicago, IL (US); Keishiro HISHINUMA, West Chicago, IL (US)

(73) Assignees: INX INTERNATIONAL INK CO., Schaumburg, IL (US); SAKATA INX CORP., Osaka (JP)

(21) Appl. No.: 13/050,504

(22) Filed: Mar. 17, 2011

(51) Int. Cl. C08K 5/3417

(52) U.S. Cl. 524/88

(57) ABSTRACT

The present invention provides a method of producing an ink composition for offset printing with use of a crude copper phthalocyanine pigment and/or an active crude copper phthalocyanine pigment and without use of a pigment dispersion resin that requires additional cost, to produce an ink composition which provides a highly tinted and bright image. The method includes the steps of: premixing a premix component through stirring so as to obtain a pigment mixture, the premix component containing a crude copper phthalocyanine pigment and/or an active crude copper phthalocyanine pigment, at least one binder resin selected from the group consisting of a rosin-modified phenolic resin, a rosin-modified maleic acid resin, a petroleum resin, and an alkyd resin, and an oil component; grinding and milling the pigment mixture obtained by the premixing, using a bead mill with grinding media of beads each having a size of 0.1 mm or larger and smaller than 1.5 mm, at a temperature within the range of 0° to 180° C., thereby obtaining a pigment dispersion; and further adding the binder resin and/or the oil component to the pigment dispersion and stirring the resulting dispersion, wherein the method satisfies the conditions that (1) the pigment mixture contains 5 to 40% by mass of the crude copper phthalocyanine pigment and/or the active crude copper phthalocyanine pigment, (2) the pigment mixture contains 5 to 500 parts by mass of the binder resin, for each 100 parts by mass of the crude copper phthalocyanine pigment and/or the active crude copper phthalocyanine pigment, and (3) the pigment mixture has a viscosity of 0.001 to 20 Pa·s at the temperature of the grinding and milling.

### TECHNICAL FIELD

The present invention relates to a method of producing an ink composition for offset printing through milling a crude copper phthalocyanine pigment and/or an active crude copper phthalocyanine pigment, using simple milling treatment and device.

### BACKGROUND ART

Copper phthalocyanine pigments are usually synthesized by a synthesis method such as the Wyler's method (urea method) and the phthalonitrile method, and such synthesized pigments, before being subjected to another treatment, are referred to as crude copper phthalocyanine pigments. These crude copper phthalocyanine pigments are an inexpensive material, and are therefore expected to be used as pigments for ink compositions. A crude copper phthalocyanine pigment, however, has a large particle size (average particle size of about 10 to 200 μm) and thus lacks tinting strength and color brightness required for a pigment, being inappropriate as a pigment for an ink composition for offset printing. Active crude copper phthalocyanine pigments produced by activating crude copper phthalocyanine pigments are also known, but they are also inappropriate as pigments for ink compositions for offset printing, for the same reason that the crude copper phthalocyanine pigments are inappropriate.

Accordingly, various methods have been provided which reduce the average particle size of a crude copper phthalocyanine pigment to about 0.01 to 0.5 μm so that the pigment can be in an appropriate state as a pigment for an ink composition for offset printing. Known methods of obtaining such fine copper phthalocyanine pigments are roughly divided into the following four methods.

(1) A method of dissolving or suspending coarse particles of a crude copper phthalocyanine pigment in a concentrated sulfuric acid or the like, and then pouring the resulting solution or suspension into a large amount of water for recrystallization

(2) A method of solvent-salt milling a crude copper phthalocyanine pigment using a mineral salt, and removing the organic solvent and the mineral salt to obtain a fine pigment (see Patent Document 1)

(3) A method of mechanically grinding coarse particles of a crude copper phthalocyanine pigment in the presence of a grinding aid and an organic liquid so as to reduce the sizes of the particles, and treating the resulting fine particles with an organic solvent or the like

(4) A method of grinding and milling, using a shot mill, a mixture containing a pigment derivative (aliphatic amine salt of copper phthalocyanine which has a sulfonic group), an organic solvent containing a binder resin, and a crude copper phthalocyanine pigment so as to obtain a pigment dispersion (see Patent Document 2)

However, method (1) requires large amounts of sulfuric acid and water, and is therefore not industrially preferable in terms of the effluent treatment.

Method (2) includes removal of an organic solvent and a mineral salt, and is thus not preferable either, in terms of the effluent treatment.

Methods (3) and (4) each require a long period of time and great energy for reduction of the particle size, and is therefore unfortunately inefficient. Further, a copper phthalocyanine pigment obtained by method (3) or (4), when used for ink, requires great energy for dispersing the aggregated particles in a vehicle. In addition, the pigment derivative of method (4) has a polar group and, in the case that the pigment is used for ink for offset printing which uses dampening water, the pigment may excessively promote emulsification of the ink. This means that the pigment considerably affects the emulsification of the ink, thereby deteriorating the qualities of the printed materials.

The present inventors have found that use of a specific pigment dispersion resin allows grinding and milling of a crude copper phthalocyanine pigment with an ordinary bead mill, and have already proposed a method of producing ink direct from a crude copper phthalocyanine pigment (see Patent Document 3).

This method, however, requires an additional pigment dispersion resin and thus increases the production cost. Hence, further improvement of the method has been desired.

Patent Document 1: JP 2002-121420 A

Patent Document 2: JP 61-163978 A

Patent Document 3: JP 11-001654 A

### SUMMARY OF THE INVENTION

### Problems to be Solved by the Invention

As above, even if an inexpensive crude copper phthalocyanine pigment is used, requirement of an additional pigment dispersion resin results in additional cost. To solve such a problem, the present invention aims to provide a method of producing an ink composition for offset printing with use of a crude copper phthalocyanine pigment and/or an active crude copper phthalocyanine pigment and without use or with a reduced amount of a pigment dispersion resin that requires additional cost, to produce an ink composition which provides highly tinted and bright image.

### Means for Solving the Problems

The present inventors have made various studies on the dispersion conditions of a crude copper phthalocyanine pigment to solve the above problems . As a result, the present inventors have found that the above problems can be solved by grinding and milling a mixture of a crude copper phthalocyanine pigment, a known binder resin, and a known oil component at lower viscosity than that at the time of milling a known pigment, with use of a bead mill that uses grinding media of finer beads than the beads for a bead mill used at the time of milling of a known pigment. Thereby, the present invention has been completed.

That is, the present invention relates to a method of producing an ink composition for offset printing, comprising the steps of:

premixing a premix component through stirring so as to obtain a pigment mixture, the premix component containing

a crude copper phthalocyanine pigment and/or an active crude copper phthalocyanine pigment,

at least one binder resin selected from the group consisting of a rosin-modified phenolic resin, a rosin-modified maleic acid resin, a petroleum resin, and an alkyd resin, and

an oil component;

grinding and milling the pigment mixture obtained by the premixing, using a bead mill with grinding media of beads each having a size of 0.1 mm or larger and smaller than 1.5 mm, at a temperature within the range of 0° C. to 180° C., thereby obtaining a pigment dispersion; and

further adding the binder resin and/or the oil component to the pigment dispersion and stirring the resulting dispersion,

wherein the method satisfies the conditions that

(1) the pigment mixture contains 5 to 40% by mass of the crude copper phthalocyanine pigment and/or the active crude copper phthalocyanine pigment,

(2) the pigment mixture contains 5 to 500 parts by mass of the binder resin, for each 100 parts by mass of the crude copper phthalocyanine pigment and/or the active crude copper phthalocyanine pigment, and

(3) the pigment mixture has a viscosity of 0.001 to 20 Pa·s at the temperature of the grinding and milling.

Here, the viscosity of the pigment dispersion obtained by the premixing is a value measured with Rheometer QCRII550 (produced by TA Instruments).

Hereinafter, the method of producing an ink composition for offset printing according to the present invention is described in more detail.

Firstly, the components used for the method of producing an ink composition for offset printing according to the present invention are described.

### (Pigment Component)

The crude copper phthalocyanine pigment and/or the active crude copper phthalocyanine pigment used for the method of producing an ink composition for offset printing according to the present invention is/are not particularly limited, and known ones having an average particle size of 4 to 200 μm can be used.

The “average particle size” herein refers to an arithmetic mean particle size determined through electron microscopic observation.

### (Binder Resin)

The binder resin used in the method of producing an ink composition for offset printing according to the present invention is at least one resin selected from the group consisting of a rosin-modified phenolic resin, a rosin-modified maleic acid resin, a petroleum resin, and an alkyd resin. Those binder resins have been conventionally used in ink compositions for offset printing, and the present invention, capable of employing such a binder resin, enables production of an ink composition for offset printing without additional cost.

Here, the binder resin may be modified product (s) of the above binder resin(s).

In the present invention, an appropriate amount (15 parts by mass or less for each 100 parts by mass of the binder resin) of a gelling agent may be used as needed, in combination with the binder resin. Use of the gelling agent in combination with the binder resin enables crosslinking of the binder resin.

Examples of the gelling agent to be used include aluminum alcoholates and aluminum chelate compounds. Preferable specific examples thereof include aluminum triisopropoxide, mono-sec-butoxy aluminum diisopropoxide, aluminum tri-sec-butoxide, ethyl acetate aluminum diisopropoxide, and aluminum tris ethyl acetoacetate.

### (Oil Component)

The oil component used in the method of producing an ink composition for offset printing according to the present invention may be an oil component such as a vegetable oil component and a mineral oil component.

Examples of the vegetable oil component include vegetable oils and fatty acid esters derived from vegetable oils. Examples of the vegetable oils include drying oils or semidrying oils suitable for offset printing, such as soybean oil, cottonseed oil, linseed oil, safflower oil, tung oil, tall oil, dehydrated castor oil, and canola oil. Each of those oils may be used alone, or two or more of the oils may be used in combination.

Examples of the fatty acid esters derived from vegetable oils include fatty acid monoalkyl esters derived from the above drying oils or semidrying oils.

The fatty acid constituting such a fatty acid monoalkyl ester is preferably a C16 to C20 saturated or unsaturated fatty acid, and examples thereof include stearic acid, isostearic acid, hydroxy stearic acid, oleic acid, linoleic acid, linolenic acid, and eleostearic acid.

The alkyl group derived from alcohol which constitutes such a fatty acid monoalkyl ester is preferably a C1 to C10 alkyl group, and examples thereof include alkyl groups such as methyl, ethyl, propyl, isopropyl, butyl, isobutyl, tert-butyl, and 2-ethylhexyl.

Each of the fatty acid monoesters derived from vegetable oils may be used alone, or two or more of the esters may be used in combination.

The mineral oil component is one that is incompatible with water and has a boiling point of 160° C. or higher, preferably 200° C. or higher. Specific examples thereof include ones conventionally used as ink solvents for offset printing petroleum solvents (e.g., n-paraffin solvents, isoparaffin solvents, naphthene solvents, aromatic solvents, and α-olefin solvents); light oils; spindle oils; machine oils; cylinder oils; turpentine oils; and mineral spirits.

### (Extender Pigment)

An extender pigment may be used in the method of producing an ink composition for offset printing according to the present invention.

The extender pigment to be used may be one conventionally used in an ink composition for offset printing, and specific examples thereof include calcium carbonate, kaolinite, organic bentonite, silica (including aerosil) and talc.

### (Additive)

In the method of producing an ink composition for offset printing according to the present invention, additive(s) such as a drier, a drying retarder, an antioxidant, an anti-scumming aid, a friction resistance improver, an anti-offset agent, and a non-ionic surfactant may be used as needed.

Next, the method of producing an ink composition for offset printing according to the present invention is described.

The method of producing an ink composition for offset printing according to the present invention includes the step of premixing a premix component through stirring so as to obtain a pigment mixture, the premix component containing a crude copper phthalocyanine pigment and/or an active crude copper phthalocyanine pigment; at least one binder resin selected from the group consisting of a rosin-modified phenolic resin, a rosin-modified maleic acid resin, a petroleum resin, and an alkyd resin; and an oil component.

In the present premixing step, in order to perform grinding without decreasing the productivity even if a bead mill with grinding media of fine beads is used in the later-described step of obtaining a pigment dispersion, the formulation of the premix component is adjusted such that the pigment mixture after the premixing has a viscosity (viscosity at the temperature of the grinding and milling in the later-described step of obtaining a pigment dispersion) of 0.001 to 20 Pa·s (condition (3)), preferably 0.02 to 4 Pa·s. Specifically, the formulation of the premix component is adjusted so that the pigment mixture to be obtained through the present step contains 5 to 40% by mass of the crude copper phthalocyanine pigment and/or the active crude copper phthalocyanine pigment (condition (1)); the pigment mixture contains 5 to 500 parts by mass of the binder resin, for each 100 parts by mass of the crude copper phthalocyanine pigment and/or the active crude copper phthalocyanine pigment (condition (2)); the pigment component includes 0 to 89.5 parts by mass of the extender pigment for each 100 parts by mass of the crude copper phthalocyanine pigment and/or the active crude copper phthalocyanine pigment; and the oil component is appropriately adjusted such that the viscosity of the pigment mixture is within the above range.

An amount of the crude copper phthalocyanine pigment and/or the active crude copper phthalocyanine pigment not satisfying condition (1), i.e., an amount of less than 5% by mass in the pigment mixture, does not cause any problem in the production, but makes it difficult to provide a composition suitable for ink. In contrast, an amount exceeding 40% by mass increases the viscosity of the base to raise a problem such as clogging in the mill, bringing difficulties to the production. The minimum amount of the crude copper phthalocyanine pigment and/or the active crude copper phthalocyanine pigment in the pigment mixture is preferably 6% by mass, and the maximum amount is preferably 30% by mass.

An amount of the binder resin not satisfying condition (2), i.e., an amount of less than 5 parts by mass for each 100 parts by mass of the crude copper phthalocyanine pigment and/or the active crude copper phthalocyanine pigment renders insufficient the dispersion of the crude copper phthalocyanine pigment and/or the active crude copper phthalocyanine pigment, causing a problem that the desired hue (IS02846-1) is not produced. In contrast, an amount exceeding 500 parts by mass gives high viscosity to the pigment mixture, which causes a problem that sufficient grinding effect cannot be provided in the premixing. The minimum amount of the binder resin is preferably 30 parts by mass, and the maximum amount is preferably 350 parts by mass.

An amount of the extender pigment exceeding 89.5 parts by mass for each 100 parts by mass of the crude copper phthalocyanine pigment and/or the active crude copper phthalocyanine pigment may result in a problem such as insufficient fluidity and inappropriate printability of the ink composition for offset printing.

In the present premixing step, a premix component having the above formulation is put into a tank that has an impeller in the interior space thereof.

Then, the premix component in the tank is premixed with the impeller rotationally driven around the rotational axis, so that a pigment mixture is obtained.

The common conditions for the premixing are that the temperature is about 80° C. and the mixing time is about 30 minutes, but the conditions are not limited thereto.

The method of producing an ink composition for offset printing according to the present invention further includes the step of grinding and milling the pigment mixture obtained by the premixing, using a bead mill with grinding media of beads each having a size of 0.1 mm or larger and smaller than 1.5 mm, at a temperature within the range of 0° C. to 180° C., thereby obtaining a pigment dispersion. In the present step, a basket mill may be used in place of the above bead mill that employs a path driving method or a circulation driving method. The grinding and milling of the pigment mixture is preferably performed for 0.1 to 10 hours. In the present step, the pigment mixture has a viscosity of 0.001 to 20 Pa·s during the grinding and milling. A viscosity of the pigment mixture of less than 0.001 Pa·s does not cause any problem in the production but makes it difficult to provide a composition suitable for ink. In contrast, a viscosity exceeding 20 Pa·s decreases the efficiency in the bead mill and the like, tending to cause a problem such as clogging.

The lowest viscosity of the pigment mixture during the grinding and milling is preferably 0.02 Pa·s, and the highest viscosity is preferably 4 Pa·s.

Further, the viscosity of the pigment mixture at room temperature (25° C.) is preferably 0.01 to 150 Pa·s. A viscosity of lower than 0.01 Pa·s may not cause any problem in the production but may make it difficult to provide a suitable composition for ink. In contrast, a viscosity exceeding 150 Pa·s may decrease the efficiency in the bead mill and the like, easily causing a problem such as clogging. The lowest viscosity of the pigment mixture at room temperature is more preferably 0.1 Pa·s, and the highest viscosity is more preferably 30 Pa·s.

The bead mill may be a vibration mill, an attritor, a horizontal bead mill, or a vertical bead mill, and specific examples thereof include an Eiger Mill, a Drais Mill, a Buhler Mill Super Flow, a Cobra Mill, a Premier Mill, and a K Mill. Specific examples of the basket mill include a Hockmeyer Mill, and a Key Mill and an MF Mill produced by Inoue MFG., Inc.

Examples of the grinding media include metal beads, glass beads, and ceramic beads. Specifically, steel beads and zirconia beads (including YTZ (registered trademark)) are preferable. A smaller size of each of the grinding media leads to higher crushing power and grinding power. Still, if the size is very small, it maybe difficult to separate the grinding media from the slurry resulting from the grinding and milling. In this regard, the size of each of the grinding media in the present invention is 0.1 mm or larger and smaller than 1.5 mm, and is preferably 0.2 to 1.0mm. A size of each of the grinding media of smaller than 0.1 mm causes disadvantage in separating the grinding media from the slurry resulting from the grinding and milling. In contrast, a size of 1.5 mm or larger leads to insufficient grinding and milling of the pigment mixture.

The temperature of the grinding and milling, which is important in the present invention, is within the temperature range of 0° C. to 180° C. A temperature exceeding 180° C. causes crystal growth of the particles of the crude copper phthalocyanine pigment and the active crude copper phthalocyanine pigment to increase the particle size. In contrast, a temperature lower than 0° C. tends to cause unpreferable crystal transition to the crude copper phthalocyanine pigment and the active crude copper phthalocyanine pigment. The lowest temperature of the grinding and milling is preferably 50° C., and the highest temperature is preferably 90° C.

In the present invention, the grinding and milling of the pigment mixture under the above conditions enables to obtain a pigment dispersion containing the copper phthalocyanine pigment and/or the active copper phthalocyanine pigment which have an average particle size of 0.05 to 0.5 μm.

The method of producing an ink composition for offset printing according to the present invention further includes the step of further adding the binder resin and/or the oil component to the pigment dispersion and stirring the resulting dispersion.

The present step is for adjusting the proportion of the respective components of the pigment dispersion such that the ink composition for offset printing, which is the final product, has a formulation suitable for offset printing.

Specifically, the binder resin and/or the oil component, and as needed, additive(s) are further added to the pigment dispersion such that, preferably, the ink composition for offset printing, which is the final product, has the following formulation: 20 to 50% by mass of the binder resin; 20 to 60% by mass of the oil component (0 to 60% by mass of a vegetable oil and 0 to 60% by mass of a mineral oil); 2 to 60% by mass of the copper phthalocyanine pigment and/or the active copper phthalocyanine pigment; 0 to 20% by mass of the extender pigment; and 0 to 20% by mass of the additive(s). The binder resin and the oil component maybe in the form of a resin varnish containing these components, when added to the pigment dispersion.

The stirring may be performed by, for example, a method of mixing using an ordinary milling device such as a mixer (disperser).

Through the present step, an ink composition for offset printing can be obtained. The additive (s) to be added as needed can alternatively be added to the premix component in the premixing.

### EFFECT OF THE INVENTION

The method of producing an ink composition for offset printing according to the present invention enables to produce an ink composition for offset printing which has excellent tinting strength and color brightness and thus is capable of providing printed materials with good qualities, with use of a crude copper phthalocyanine pigment and/or an active crude copper phthalocyanine pigment which are inexpensive. The method eliminates the need for use of an additional pigment dispersion resin, thereby suppressing an increase in the production cost.

### MODES FOR CARRYING OUT THE INVENTION

Hereinafter, the present invention will be described by way of Examples. The present invention, however, is not limited to these Examples and many modifications and variations are possible as long as they do not depart from the gist and the scope of the present invention. Also, “%” refers to “% by mass” and “part(s)” refer(s) to “part(s) by mass”, unless otherwise noted.

### Example 1

A tank having an impeller in the interior space thereof was charged with 70 parts of resin varnish A [resin concentration: 45% by mass, formed by heat-dissolving a rosin-modified phenolic resin (PM1266) produced by Arez and a petroleum resin (Neville1850) produced by Neville, in solvents Nos. 4 and 5 and soybean oil]; 10 parts of the solvent No. 5; 7 parts of kaolin (brand name: #27 HYDROUS KAOLIN CLAY, produced by Burgess) as an extender pigment; and 13 parts of an active crude copper phthalocyanine pigment (produced by Meghmani, average particle size: about 7 μm). The materials were premixed through sufficient stirring at 80° C., so that a pigment mixture (1) having a viscosity of 2 Pa·s (80° C.) was prepared.

Next, 100 parts of the pigment mixture (1) obtained thereby was put into an Eiger Mill (provided with a filtration screen with an opening size of 0.35 mm), which was 80% filled with steel beads each having a size of 1.0mm. The mixture (1) was ground and milled at 80° C. for 30 minutes so that a pigment dispersion (1) was obtained.

To 80 parts of the pigment dispersion (1) was further added 20 parts of the resin varnish A, and the resulting dispersion was stirred. Thereby, an ink composition (1) for offset printing was obtained.

### Example 2

A tank having an impeller in the interior space thereof was charged with 70 parts of resin varnish B [resin concentration: 45% by mass, formed by heat-dissolving a rosin-modified maleic acid resin (3790) produced by Hexion and a petroleum resin (Neville1850) produced by Neville, in solvents Nos. 4 and 5 and soybean oil]; 10 parts of the solvent No. 5; 7 parts of kaolin (brand name: #27 HYDROUS KAOLIN CLAY, produced by Burgess) as an extender pigment; and 13 parts of an active crude copper phthalocyanine pigment (produced by Meghmani, average particle size: about 7 μm). The materials were premixed through sufficient stirring at 80° C. for 30 minutes, so that a pigment mixture (2) having a viscosity of 2 Pa·s (80° C.) was prepared.

Next, 100 parts of the pigment mixture (2) obtained thereby was put into an Eiger Mill (provided with a filtration screen with an opening size of 0.35 mm), which was 80% filled with steel beads each having a size of 1.0 mm. The mixture (2) was ground and milled at 80° C. for 30 minutes, so that a pigment dispersion (2) was obtained.

To 80 parts of the pigment dispersion (2) was further added 20 parts of the resin varnish B, and the resulting dispersion was stirred. Thereby, an ink composition (2) for offset printing was obtained.

### Example 3

A tank having an impeller in the interior space thereof was charged with 70 parts of resin varnish A [resin concentration: 45% by mass, formed by heat-dissolving a rosin-modified phenolic resin (PM1266) produced by Arez and a petroleum resin (Neville1850) produced by Neville, in solvents Nos. 4 and 5 and soybean oil]; 10 parts of the solvent No. 5; 7 parts of kaolin (brand name: #27 HYDROUS KAOLIN CLAY, produced by Burgess) as an extender pigment; and 13 parts of an active crude copper phthalocyanine pigment (produced by Meghmani, average particle size: about 7 μm). The materials were premixed through sufficient stirring at 80° C., so that a pigment mixture (3) having a viscosity of 2 Pa·s (80° C.) was prepared.

Next, 100 parts of the pigment mixture (3) obtained thereby was put into an Eiger Mill (provided with a filtration screen with an opening size of 0.35 mm), which was 80% filled with steel beads each having a size of 0.5 mm. The mixture (3) was ground and milled at 80° C. for 20 minutes, so that a pigment dispersion (3) was obtained.

To 80 parts of the pigment dispersion (3) was further added 20 parts of the resin varnish A, and the resulting dispersion was stirred. Thereby, an ink composition (3) for offset printing was obtained.

### Example 4

A tank having an impeller in the interior space thereof was charged with 20 parts of petroleum resin varnish R2612 (solid content: 65%, produced by Resinall); 10 parts of R5364 (solid content: 52%, produced by Resinall); 15 parts of solvent No. 5; 15 parts of solvent No. 4; 10 parts of kaolin (brand name: #27 HYDROUS KAOLIN CLAY, produced by Burgess) as an extender pigment; 20 parts of an active crude copper phthalocyanine pigment (produced by Meghmani, average particle size: about 7 μm); and 10 parts of soybean oil. The materials were premixed through sufficient stirring at 80° C., so that a pigment mixture (4) having a viscosity of 0.1 Pa·s (80° C.) was prepared.

Next, 100 parts of the pigment mixture (4) obtained thereby was put into an Eiger Mill (provided with a filtration screen with an opening size of 0.35 mm), which was 80% filled with steel beads each having a size of 1.0 mm. The mixture (4) was ground and milled at 80° C. for 20 minutes, so that a pigment dispersion (4) was obtained.

To 60 parts of the pigment dispersion (4) was further added 20 parts of the R5364 (produced by Resinall) and 20 parts of resin varnish C [resin concentration: 60% by mass, formed by heat-dissolving a rosin-modified phenolic resin (PM1266) produced by Arez in solvents Nos. 4 and 5], and the resulting dispersion was stirred. Thereby, an ink composition (4) for offset printing was obtained.

### Example 5

A tank having an impeller in the interior space thereof was charged with 20 parts of petroleum resin varnish R2612 (solid content: 65%, produced by Resinall); 10 parts of R5364 (solid content: 52%, produced by Resinall); 15 parts of solvent No. 5; 15 parts of solvent No. 4; 10 parts of kaolin (brand name: #27 HYDROUS KAOLIN CLAY, produced by Burgess) as an extender pigment; 20 parts of a crude copper phthalocyanine pigment (produced by Meghmani, average particle size: about 30 μm); 7 parts of soybean oil; and 3 parts of a solsperse 5000. The materials were premixed through sufficient stirring at 80° C., so that a pigment mixture (5) having a viscosity of 0.1 Pa·s (80° C.) was prepared.

Next, 100 parts of the pigment mixture (5) obtained thereby was put into an Eiger Mill (provided with a filtration screen with an opening size of 0.15 mm), which was 80% filled with steel beads each having a size of 0.3 mm. The mixture (5) was ground and milled at 80° C. for 30 minutes, so that a pigment dispersion (5) was obtained.

To 60 parts of this pigment dispersion (5) was further added 20 parts of the R5364 (produced by Resinall) and 20 parts of resin varnish C [resin concentration: 60% by weight, formed by heat-dissolving a rosin-modified phenolic resin (PM1266) produced by Arez in solvents Nos. 4 and 5], and the resulting dispersion was stirred. Thereby, an ink composition (5) for offset printing was obtained.

### Example 6

A tank having an impeller in the interior space thereof was charged with 65 parts of resin varnish A [resin concentration: 45% by mass, formed by heat-dissolving a rosin-modified phenolic resin (PM1266) produced by Arez and a petroleum resin (Neville1850) produced by Neville, in solvents Nos. 4 and 5 and soybean oil]; 10 parts of the solvent No. 5; 7 parts of kaolin (brand name: #27 HYDROUS KAOLIN CLAY, produced by Burgess) as an extender pigment; 13 parts of an active crude copper phthalocyanine pigment (produced by Meghmani, average particle size: about 7 μm); and 5 parts of an alkyd resin (produced by Hexion, LV807). The materials were premixed through sufficient stirring at 80° C., so that a pigment mixture (6) having a viscosity of 1.5 Pa·s (80° C.) was prepared.

Next, 100 parts of the pigment mixture (6) obtained thereby was put into an Eiger Mill (provided with a filtration screen with an opening size of 0.35 mm), which was 80% filled with steel beads each having a size of 1.0 mm. The mixture (6) was ground and milled at 80° C. for 30 minutes, so that a pigment dispersion (6) was obtained.

To 80 parts of the pigment dispersion (6) was further added 20 parts of the resin varnish A, and the resulting dispersion was stirred. Thereby, an ink composition (6) for offset printing was obtained.

### Example 7

A tank having an impeller in the interior space thereof was charged with 70 parts of resin varnish A [resin concentration: 45% by mass, formed by heat-dissolving a rosin-modified phenolic resin (PM1266) produced by Arez and a petroleum resin (Neville1850) produced by Neville, in solvents Nos. 4 and 5 and soybean oil]; 10 parts of the solvent No. 5; and 20 parts of an active crude copper phthalocyanine pigment (produced by Meghmani, average particle size: about 7 μm). The materials were premixed through sufficient stirring at 80° C., so that a pigment mixture (7) having a viscosity of 3 Pa·s (80° C.) was prepared.

Next, 100 parts of the pigment mixture (7) obtained thereby was put into an Eiger Mill (provided with a filtration screen with an opening size of 0.35 mm), which was 80% filled with steel beads each having a size of 1.0 mm. The mixture (7) was ground and milled at 80° C. for 30 minutes, so that a pigment dispersion (7) was obtained.

To 80 parts of the pigment dispersion (7) was further added 20 parts of the resin varnish A, and the resulting dispersion was stirred. Thereby, an ink composition (7) for offset printing was obtained.

### Example 8

A tank having an impeller in the interior space thereof was charged with 20 parts of petroleum resin varnish R2612 (solid content: 65%, produced by Resinall); 10 parts of R5364 (solid content: 52%, produced by Resinall); 15 parts of solvent No. 5; 15 parts of solvent No. 4; 10 parts of kaolin (brand name: #27 HYDROUS KAOLIN CLAY, produced by Burgess) as an extender pigment; 20 parts of a crude copper phthalocyanine pigment (produced by Meghmani, average particle size: about 30 μm); and 10 parts of soybean oil. The materials were premixed through sufficient stirring at 80° C., so that a pigment mixture (8) having a viscosity of 0.1 Pa·s (80° C.) was prepared.

Next, 100 parts of the pigment mixture (8) obtained thereby was put into an Eiger Mill (provided with a filtration screen with an opening size of 0.15 mm), which was 80% filled with steel beads each having a size of 0.3 mm. The mixture (8) was ground and milled at 80° C. for three hours, so that a pigment dispersion (8) was obtained.

To 60 parts of the pigment dispersion (8) was further added 20 parts of the R5364 (produced by Resinall) and 20 parts of resin varnish C [resin concentration: 60% by mass, formed by heat-dissolving a rosin-modified phenolic resin (PM1266) produced by Arez in solvents Nos. 4 and 5], and the resulting dispersion was stirred. Thereby, an ink composition (8) for offset printing was obtained.

### Example 9

A tank having an impeller in the interior space thereof was charged with 70 parts of resin varnish A [resin concentration: 45% by mass, formed by heat-dissolving a rosin-modified phenolic resin (PM1266) produced by Arez and a petroleum resin (Neville1850) produced by Neville, in solvents Nos. 4 and 5 and soybean oil]; 10 parts of the solvent No. 5; 7 parts of kaolin (brand name : #27 HYDROUS KAOLIN CLAY, produced by Burgess) as an extender pigment; and 13 parts of an active crude copper phthalocyanine pigment (produced by Meghmani, average particle size: about 7 μm). The materials were premixed through sufficient stirring at 80° C., so that a pigment mixture (9) having a viscosity of 0.7 Pa·s (140° C.) was prepared.

Next, 100 parts of the pigment mixture (9) obtained thereby was put into an Eiger Mill (provided with a filtration screen with an opening size of 0.35 mm), which was 80% filled with steel beads each having a size of 1.0 mm. The mixture (9) was ground and milled at 140° C. for 30 minutes, so that a pigment dispersion (9) was obtained.

To 80 parts of the pigment dispersion (9) was further added 20 parts of the resin varnish A, and the resulting dispersion was stirred. Thereby, an ink composition (9) for offset printing was obtained.

### Example 10

A tank having an impeller in the interior space thereof was charged with 20 parts of petroleum resin varnish R2612 (solid content: 65%, produced by Resinall); 10 parts of R5364 (solid content: 52%, produced by Resinall); 15 parts of solvent No. 5; 15 parts of solvent No. 4; 10 parts of kaolin (brand name: #27 HYDROUS KAOLIN CLAY, produced by Burgess) as an extender pigment; 20 parts of an active crude copper phthalocyanine pigment (produced by Meghmani, average particle size: about 7 μm; and 10 parts of soybean oil. The materials were premixed through sufficient stirring at 25° C., so that a pigment mixture (10) having a viscosity of 0.3 Pa·s (25° C.) was prepared.

Next, 100 parts of the pigment mixture (10) obtained thereby was put into an Eiger Mill (provided with a filtration screen with an opening size of 0.35 mm), which was 80% filled with steel beads each having a size of 1.0 mm. The mixture (10) was ground and milled at 25° C. for 30 minutes, so that a pigment dispersion (10) was obtained.

To 60 parts of the pigment dispersion (10) was further added 20 parts of the R5364 (produced by Resinall) and 20 parts of resin varnish C [resin concentration: 60% by mass, formed by heat-dissolving a rosin-modified phenolic resin (PM1266) produced by Arez in solvents Nos. 4 and 5], and the resulting dispersion was stirred. Thereby, an ink composition (10) for offset printing was obtained.

### Comparative Example 1

A tank having an impeller in the interior space thereof was charged with 70 parts of resin varnish A [resin concentration: 45% by mass, formed by heat-dissolving a rosin-modified phenolic resin (PM1266) produced by Arez and a petroleum resin (Neville1850) produced by Neville, in solvents Nos. 4 and 5 and soybean oil]; 10 parts of the solvent No. 5; 7 parts of kaolin (brand name: #27 HYDROUS KAOLIN CLAY, produced by Burgess) as an extender pigment; and 13 parts of an active crude copper phthalocyanine pigment (produced by Meghmani, average particle size: about 7 μm). The materials were premixed through sufficient stirring at 80° C., so that a pigment mixture (11) having a viscosity of 2 Pa·s (80° C.) was prepared.

Next, 100 parts of the pigment mixture (11) obtained thereby was put into an Eiger Mill (provided with a filtration screen with an opening size of 0.35 mm), which was 80% filled with steel beads each having a size of 2.3 mm. The mixture (11) was ground and milled at 80° C. for 30 minutes, so that a pigment dispersion (11) was obtained.

To 80 parts of the pigment dispersion (11) was further added 20 parts of the resin varnish A, and the resulting dispersion was stirred. Thereby, an ink composition (11) for offset printing was obtained.

### Comparative Example 2

A tank having an impeller in the interior space thereof was charged with 20 parts of petroleum resin-dissolved varnish R2612 (solid content: 65%) produced by Resinall; 10 parts of petroleum resin-dissolved varnish R5364 (solid content: 52%) produced by Resinall; 15 parts of solvent No. 5; 15 parts of solvent No. 4; 10 parts of kaolin (brand name: #27 HYDROUS KAOLIN CLAY, produced by Burgess) as an extender pigment; 20 parts of an active crude copper phthalocyanine pigment (produced by Meghmani, average particle size: about 7 μm); and 10 parts of soybean oil. The materials were premixed through sufficient stirring at 80° C., so that a pigment mixture (12) having a viscosity of 0.1 Pa·s (80° C.) was prepared.

Next, 100 parts of the pigment mixture (12) obtained thereby was put into an Eiger Mill (provided with a filtration screen with an opening size of 0.35 mm), which was 80% filled with steel beads each having a size of 2.3 mm. The mixture (12) was ground and milled at 80° C. for 30 minutes, so that a pigment dispersion (12) was obtained.

To 60 parts of the pigment dispersion (12) was further added 20 parts of the R5364 (produced by Resinall) and 20 parts of resin varnish C [resin concentration: 60% by mass, formed by heat-dissolving a rosin-modified phenolic resin (PM1266) produced by Arez in solvents Nos. 4 and 5], and the resulting dispersion was stirred. Thereby, an ink composition (12) for offset printing was obtained.

### Comparative Example 3

A tank having an impeller in the interior space thereof was charged with 20 parts of petroleum resin-dissolved varnish R2612 (solid content: 65%) produced by Resinall; 10 parts of petroleum resin-dissolved varnish R5364 (solid content: 52%) produced by Resinall; 15 parts of solvent No. 5; 15 parts of solvent No. 4; 10 parts of kaolin (brand name: #27 HYDROUS KAOLIN CLAY, produced by Burgess) as an extender pigment; 20 parts of an active crude copper phthalocyanine pigment (produced by Meghmani, average particle size: about 7 μm); and 10 parts of soybean oil. The materials were premixed through sufficient stirring at 80° C., so that a pigment mixture (13) having a viscosity of 0.1 Pa·s (80° C.) was prepared.

Next, 100 parts of the pigment mixture (13) obtained thereby was put into an Eiger Mill (provided with a filtration screen with an opening size of 0.35 mm), which was 80% filled with steel beads each having a size of 1.5 mm. The mixture (13) was ground and milled at 80° C. for 30 minutes, so that a pigment dispersion (13) was obtained.

To 60 parts of the pigment dispersion (13) was further added 20 parts of the R5364 (produced by Resinall) and 20 parts of resin varnish C [resin concentration: 60% by mass, formed by heat-dissolving a rosin-modified phenolic resin (PM1266) produced by Arez in solvents Nos. 4 and 5], and the resulting dispersion was stirred. Thereby, an ink composition (13) for offset printing was obtained.

### Comparative Example 4

A tank having an impeller in the interior space thereof was charged with 80 parts of resin varnish C [resin concentration: 60% by mass, formed by heat-dissolving a rosin-modified phenolic resin (PM1266) produced by Arez in solvents Nos. 4 and 5 ], 7 parts of kaolin (brand name : #27 HYDROUS KAOLIN CLAY, produced by Burgess) as an extender pigment; and 13 parts of an active crude copper phthalocyanine pigment (produced by Meghmani, average particle size: about 7 μm). The materials were premixed through sufficient stirring at 80° C., so that a pigment mixture (14) having a viscosity of 21 Pa·s (80° C.) was prepared.

Next, 100 parts of the pigment mixture (14) obtained thereby was put into an Eiger Mill (provided with a filtration screen with an opening size of 0.35 mm), which was 80% filled with steel beads each having a size of 1.0 mm. The mixture, however, had very high viscosity, and therefore could not be dispersed.

### Reference Example 1

A tank having an impeller in the interior space thereof was charged with 70 parts of resin varnish A [resin concentration: 45% by mass, formed by heat-dissolving a rosin-modified phenolic resin (PM1266) produced by Arez and a petroleum resin (Neville1850) produced by Neville, in solvents Nos. 4 and 5 and soybean oil]; 10 parts of the solvent No. 5; 7 parts of kaolin (brand name: #27 HYDROUS KAOLIN CLAY, produced by Burgess) as an extender pigment; and 13 parts of a copper phthalocyanine pigment (produced by Meghmani, average particle size: about 13 μm). The materials were premixed through sufficient stirring at 80° C., so that a pigment mixture (15) having a viscosity of 2 Pa·s (80° C.) was prepared.

Next, 100 parts of the pigment mixture (15) obtained thereby was put into an Eiger Mill (provided with a filtration screen with an opening size of 0.35 mm), which was 80% filled with steel beads each having a size of 2.3 mm. The mixture (15) was ground and milled at 80° C. for 30 minutes, so that a pigment dispersion (15) was obtained.

To 80 parts of the pigment dispersion (15) was further added 20 parts of the resin varnish A, and the resulting dispersion was stirred. Thereby, an ink composition (15) for offset printing was obtained.

### Evaluation Test

Each of the ink compositions for offset printing was evaluated for the following properties. Table 1 shows the evaluation results.

### (1) Tinting Strength

A pigment dispersion for white ink was added to each of the pigment dispersions of Examples and Comparative Examples. Here, the tinting strength of the pigment dispersion (15) according to Reference Example, prepared using a copper phthalocyanine pigment, was taken as 100%. Based on this, the tinting strength of each of the pigment dispersions of Examples and Comparative Examples was determined by determining the relative amount of the pigment dispersion for white ink required for each composition to provide the same degree of the tinting strength as the pigment dispersion (15). A higher value shows higher tinting strength.

### (2) Hue, Transparency

Each ink composition for offset printing was spread on APCOII (produced by Scheufelen) and Leneta paper (produced by Leneta), being designated papers, to a thickness of 0.7 to 1.3 μm in a volume specified for HS ink. Compared with the standard values of L=57.0, a=−39.2, and b=−46.0, each ink composition was tested to determine whether the composition had a ΔE value of 4 or less and a transparency T of 0.2 or more, using “Spectrodensitometer Mode1530” produced by X-Rite.

Further, the transparency was measured based on ISO 2846-1.

### (3) Printability

Each of the ink compositions for offset printing was subjected to actual printing with an offset printing machine produced by Mitsubishi Heavy Industries Printing & Packaging Machinery Ltd., for evaluation of the overall printability by determining water window, fluidity of the ink composition, transferability of the ink composition, and stains on the paper.

The ink compositions were evaluated as 3 if they had a wide water window and provided good printed materials. The ink compositions were evaluated as 2 if they had a narrow water window and caused many stains on the printing materials. The ink compositions were evaluated as 1 if they did not have printability at all.

TABLE 1

| | Tinting | | | |
|---|---|---|---|---|
| | strength | Hue | Transparency | Printability |
| Example 1 | 100 | 2.60 | 0.42 | 3 |
| Example 2 | 100 | 2.42 | 0.42 | 3 |
| Example 3 | 100 | 2.85 | 0.51 | 3 |
| Example 4 | 100 | 3.55 | 0.61 | 3 |
| Example 5 | 100 | 3.31 | 0.51 | 3 |
| Example 6 | 100 | 3.88 | 0.55 | 3 |
| Example 7 | 100 | 2.55 | 0.41 | 3 |
| Example 8 | 100 | 3.99 | 0.43 | 3 |
| Example 9 | 100 | 2.70 | 0.44 | 3 |
| Example 10 | 100 | 2.81 | 0.41 | 3 |
| Comparative | 80 | 5.21 | 0.39 | 2 |
| Example 1 | | | | |
| Comparative | 75 | 7.66 | 0.41 | 1 |
| Example 2 | | | | |
| Comaprative | 80 | 5.88 | 0.51 | 2 |
| Example 3 | | | | |
| Comparative | 67 | 10.22 | 0.41 | 1 |
| Example 4 | | | | |
| Reference | 100 | 2.41 | 0.72 | 3 |
| Example 1 | | | | |

The results in Table 1 show that the ink compositions for offset printing according to Examples provided excellent tinting strength, hue, and printability.

In contrast, the ink compositions for offset printing according to Comparative Examples 1 to 3 provided inferior tinting strength and printability because the large size of grinding media used in the grinding and milling of the pigment mixture led to insufficient grinding of the pigment mixture. The ink composition for offset printing according to Comparative Example 4 also provided inferior tinting strength and printability because the pigment mixture had high viscosity when ground and milled, which led to insufficient dispersion of the pigment component.

### INDUSTRIAL APPLICABILITY

The method of producing an ink composition for offset printing according to the present invention provides an ink composition for offset printing which provides a highly tinted and bright image, with use of a crude copper phthalocyanine pigment and/or an active crude copper phthalocyanine pigment and without use of a pigment dispersion resin that requires additional cost.

1. A method of producing an ink composition for offset printing, comprising the steps of:
premixing a premix component through stirring so as to obtain a pigment mixture, the premix component containing
a crude copper phthalocyanine pigment and/or an active crude copper phthalocyanine pigment,
at least one binder resin selected from the group consisting of a rosin-modified phenolic resin, a rosin-modified maleic acid resin, a petroleum resin, and an alkyd resin, and
an oil component;
grinding and milling the pigment mixture obtained by the premixing, using a bead mill with grinding media of beads each having a size of 0.1 mm or larger and smaller than 1.5 mm, at a temperature within the range of 0° C. to 180° C., thereby obtaining a pigment dispersion; and
further adding the binder resin and/or the oil component to the pigment dispersion and stirring the resulting dispersion,
wherein the method satisfies the conditions that
(1) the pigment mixture contains 5 to 40% by mass of the crude copper phthalocyanine pigment and/or the active crude copper phthalocyanine pigment,
(2) the pigment mixture contains 5 to 500 parts by mass of the binder resin, for each 100 parts by mass of the crude copper phthalocyanine pigment and/or the active crude copper phthalocyanine pigment, and
(3) the pigment mixture has a viscosity of 0.001 to 20 Pa·s at the temperature of the grinding and milling.
